(19) United States
(12) Patent Application Publication
(10) Pub. No.: US 2025/0321373 A1
(43) Pub. Date: Oct. 16, 2025

(54) METHOD FOR SPLICING OPTICAL ELEMENTS, OPTICAL ELEMENT AND HEAD-MOUNTED DISPLAY DEVICE

(71) Applicants: INTERFACE OPTOELECTRONICS (SHENZHEN) CO., LTD., Shenzhen (CN); Interface Technology (ChengDu) Co., Ltd., Chengdu (CN); GENERAL INTERFACE SOLUTION LIMITED, Zhunan (TW)

(72) Inventors: NAN-TSUN KUO, Zhunan (TW); Po-Lun Chen, Zhunan (TW); Yun-Pei Chen, New Taipei (TW)

(21) Appl. No.: 18/734,580

(22) Filed: Jun. 5, 2024

(30) Foreign Application Priority Data
Apr. 12, 2024 (CN) 202410445604.0

(51) Int. Cl. F21V 8/00

(52) U.S. Cl. CPC G02B 6/0078; G02B 6/0016; G02B 6/0036; G02B 6/0065; G02B 6/0088

(57) ABSTRACT

Embodiments of the present disclosure relates to a method for splicing optical elements. The method includes providing and splicing a first optical element and a second optical element. The first optical element includes a first substrate having a first splicing surface and at least one protrusion protruding from the first splicing surface toward a side away from the first substrate. The second optical element includes a second substrate having a second splicing surface and at least one recess recessed from the second splicing surface toward the second substrate. After the first optical element and the second optical element are spliced, the first splicing surface is joined to the second splicing surface, and each recess is interference-fitted with a corresponding one protrusion.

### FIELD

The subject matter herein generally relates to optical element processing, specifically to a method for splicing optical elements, an optical element obtained by the method, and a display device using the optical element.

### BACKGROUND

For optical elements with a microstructure layer on both sides, due to limitations in manufacturing equipment during actual industrial production, it is difficult to manufacture large-sized optical elements at one time. Therefore, it is often necessary to obtain a larger-sized optical element by bonding or splicing multiple smaller-sized optical elements. The existing technology mainly uses optical glue to bond or uses clamps to assemble and splice such optical elements. When optical glue is used to bond such optical elements, the optical glue will shrink in volume after curing, causing the relative positions of the optical elements after curing to shift relative to the relative positions of the optical elements before curing, thus affecting the performance and light output of the spliced optical elements. When clamps are used to assemble and splice such optical elements, due to errors in the clamps themselves, assembly deviation occurs during the working process of the clamps and it is difficult to align, thus affecting the performance and light output of the spliced optical elements.

Therefore, there is room for improvement in the art.

### BRIEF DESCRIPTION OF THE DRAWINGS

Implementations of the present disclosure will now be described, by way of embodiment, with reference to the attached figures.

FIG. 1 is a schematic flowchart of a method for splicing optical elements according to an embodiment of present disclosure.

FIG. 2 is a schematic flowchart of an injection integrated molding method according to an embodiment of present disclosure.

FIG. 3 is a schematic structural diagram of a first optical element and a second optical element according to an embodiment of present disclosure.

FIG. 4 is a schematic structural diagram of an optical element after splicing according to a first embodiment of present disclosure.

FIG. 5 is a partial cross-sectional view along line V-V of FIG. 4.

FIG. 6 is a partial cross-sectional view along line VI-VI of FIG. 4.

FIG. 7 is a partial cross-sectional view of an optical element after splicing according to a second embodiment of present disclosure.

FIG. 8 is a partial cross-sectional view of an optical element after splicing according to a third embodiment of present disclosure.

FIG. 9 is a schematic structural diagram of an optical element after splicing according to a fourth embodiment of present disclosure.

FIG. 10 is a schematic structural diagram of an optical element according to a fifth embodiment of present disclosure.

FIG. 11 is a schematic structural diagram of a display device according to an embodiment of present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth to provide a thorough understanding of the exemplary embodiments described herein. However, it will be understood by those of ordinary skill in the art that the exemplary embodiments described herein may be practiced without these specific details. In other instances, methods, procedures, and elements have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”.

In other invention applications of the applicant, an optical element is proposed. The optical element includes a substrate, a first microstructure layer and a second microstructure layer. The substrate includes a lower surface and an upper surface opposite the lower surface. The first microstructure layer is on the lower surface of the substrate. The first microstructure layer includes a plurality of first protrusions. The first protrusions are in contact with the substrate and protrude toward a side away from the substrate. Each first protrusion includes a first light-transmitting surface for transmitting light. The second microstructure layer is on the upper surface of the substrate. The second microstructure layer includes a plurality of second protrusions. The second protrusions are in contact with the substrate and protruding toward a side away from the substrate. Each second protruding protrusion includes a second light-transmitting surface for transmitting light, and the first light-transmitting surface is parallel to the second light-transmitting surface.

For optical element with a microstructure layer on both upper and lower surfaces, due to limitations of manufacturing equipment in the actual industrial production process, it is difficult to prepare such large-sized optical elements at one time, so it is often necessary to obtain large-sized optical elements by bonding or splicing multiple larger-sized optical elements. The existing technology easily causes the relative position between the two optical elements after splicing to deviate from that before splicing. After two optical elements are spliced, the first light-transmitting surface of the first protrusion of one optical element and the second light-transmitting surface of the second protrusion of the other optical element cannot form a preset parallel relationship, thereby affecting the performance and light emitting efficiency of the spliced optical elements.

The present disclosure proposes a method for splicing optical elements. The method for splicing optical elements of the present disclosure is particularly suitable for, but is not limited to, splicing between the above-mentioned optical elements that have microstructure layers on the upper and lower surfaces and require a preset alignment relationship between the microstructure layers.

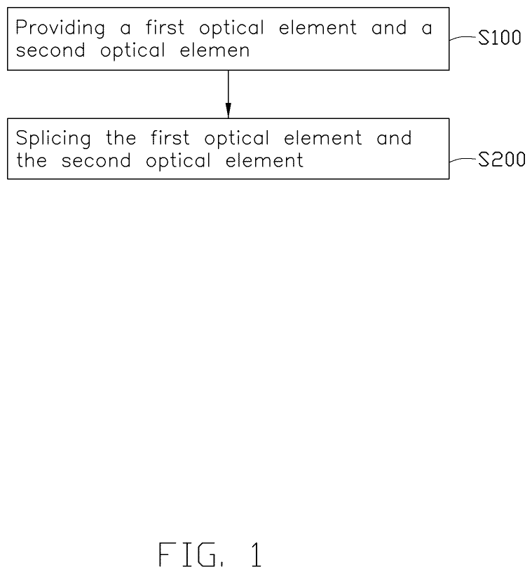

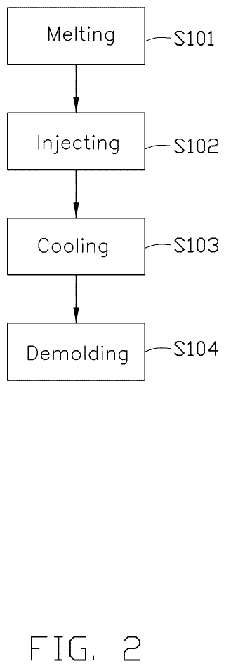

FIG. 1 shows a flowchart of a method for splicing optical elements according to an embodiment. The example method is provided by way of example, as there are a variety of ways to carry out the method. The method described below can be carried out using the configurations illustrated in FIGS. 2 through 10, for example, and various elements of these figures are referenced in explaining the example method. Each block shown in FIG. 1 represents one or more processes, methods, or subroutines carried out in the example method. Furthermore, the illustrated order of blocks is by example only, and the order of the blocks can be changed. Additional blocks can be added, or fewer blocks can be utilized, without departing from this disclosure. The example method can begin at block S100.

In block S100, a first optical element and a second optical element are provided. The first optical element includes a first substrate having a first splicing surface, and at least one protrusion protruding from the first splicing surface toward a side away from the first substrate. The second optical element includes a second substrate having a second splicing surface and at least one recess recessed from the second splicing surface toward the second substrate. The number of at least one recess is the same as the number of at least one protrusion, and each recess is configured to accommodate a corresponding one protrusion.

In block S200, the first optical element and the second optical element are spliced. The first splicing surface is joined to the second splicing surface, and each recess is interference-fitted with the corresponding one protrusion.

In the method for splicing optical elements according to the embodiment, one or more protrusions are provided on the first splicing surface of the first optical element to be spliced, and the same number of grooves as the protrusions are provided on the second splicing surface of the second optical element to be spliced. After the first splicing surface and the second splicing surface are spliced, each groove accommodates a corresponding protrusion, so that the first optical element and the second optical element can be accurately spliced, which is beneficial to splicing different types of optical elements, reducing the positional deviation between the first splicing surface and the second splicing surface after splicing, and improving the performance and light output efficiency of the spliced optical elements.

As shown in FIG. 2, the block S100 includes forming the first optical element and the second optical element respectively by an injection integral molding method. The steps of forming the first optical element and the second optical element by the injection integral molding method both include blocks S101 to S104.

In block S101, a raw material of the first optical element is heated to obtain a first molten raw material, and a raw material of the second optical element is heated to obtain a second molten raw material.

In block S102, the first molten raw material is injected into a first mold, and the second molten raw material is injected into a second mold.

In block S103, the first molten raw material in the first mold is cooled to obtain a cooled first optical element, and the second molten raw material in the second mold is cooled to obtain a cooled second optical element.

In block S104, the cooled first optical element is demolded from the first mold, and the cooled second optical element is demolded from the second mold.

In one embodiment, blocks S101 to S104 are completed by an injection molding machine. In block S101, the raw materials of the first optical element or the second optical element are melted at high temperature in a material tube of the injection molding machine. According to the material properties of the selected raw materials, the raw materials are melted on the injection molding machine.

Specifically, the raw material of the first optical element is, but is not limited to, any one of glass, polyethylene glycol terephthalate (PET), polycarbonate (PC), polymethyl methacrylate (PMMA), acrylonitrile-butadiene-styrene copolymer (ABS) and polyurethane. The raw material of the second optical element is, but is not limited to, any one of glass, PET, PC, PMMA, ABS and polyurethane. The materials of the first optical element and the second optical element may be the same or different.

In block S102, the injection molding machine fills and injects the melted raw materials into the mold and uses the design space of the mold to shape the raw materials. The parameters of the injection molding machine need to be adjusted according to the injection molding conditions of the raw materials or the mold conditions to avoid subsequent problems such as dimensional inconsistency or burrs. After the raw materials are filled into the mold, the spaces in the mold continue to be pressurized to ensure the tightness of filling of these raw materials, thereby effectively avoiding the backflow of raw materials.

The maximum length and width of the first mold are 1000 mm×1000 mm, and the maximum length and width of the second mold are 1000 mm×1000 mm. When the length and width of the first mold and the second mold are less than 1000 mmx 1000 mm, a good splicing effect can be obtained without affecting the performance and light emitting efficiency of the spliced optical elements.

In block S103, the molten raw material in the mold of the injection molding machine is rapidly cooled and shaped. In other embodiments, blocks S101 to S104 can be completed manually.

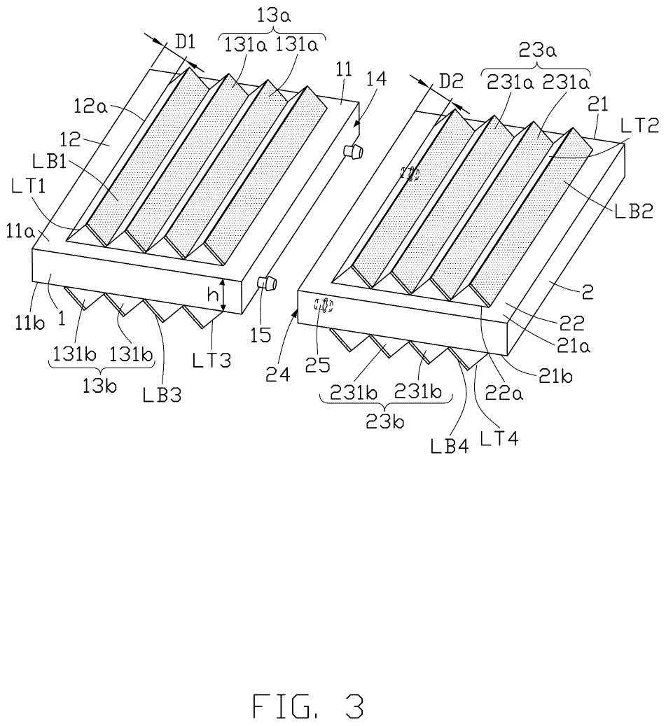

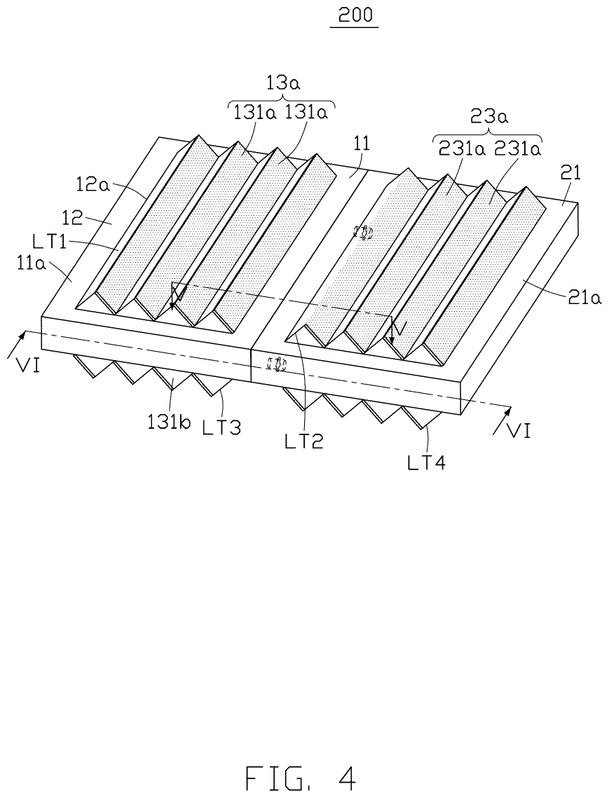

As shown in FIG. 3 and FIG. 4, the first substrate 11 includes a first surface 11a connected to the first splicing surface 14. The first optical element 1 further includes a first microstructure layer 13a on the first surface 11a. The first microstructure layer 13a includes a plurality of first prisms 131a. Each first prism 131a includes a first light-transmitting surface LT1 for transmitting light and a first light-blocking surface LB1 for blocking light.

The second substrate 21 includes a second surface 21a connected to the second splicing surface 24. The second optical element further includes a second microstructure layer 23a having a same size and shape as the first microstructure layer 13a on the second surface 21a. The second microstructure layer 23a includes a plurality of second prisms 231a. Each second prism 231a includes a second light-transmitting surface LT2 for transmitting light and a second light-blocking surface LB2 for blocking light.

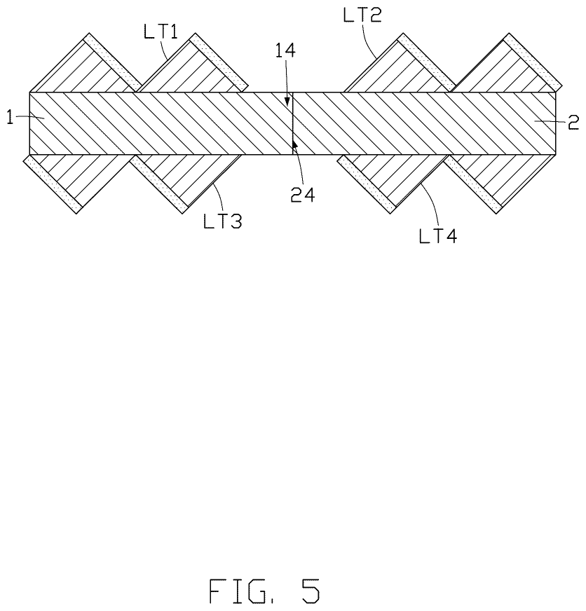

As shown in FIG. 4 and FIG. 5, after the first optical element 1 and the second optical element are spliced, an optical element 200 is obtained. The first splicing surface 14 and the second splicing surface 24 are joined, the second surface 21a is coplanar with the first surface 11a, and the second microstructure layer 23a is aligned with the first microstructure layer 13a. The second light-transmitting surface LT2 of each second prism 231a is parallel to the first light-transmitting surface LT1 of any one of the first prisms 131a, and the second light-blocking surface LB2 of each second prism 231a is parallel to the first light-blocking surface LB1 of any one of the first prisms 131a.

As shown in FIG. 3, the first substrate 11 further includes a third surface 11b connected to the first splicing surface 14 and opposite to the first surface 11a. The second substrate 21 further includes a fourth surface 21b connected to the second splicing surface 24 and opposite to the second surface 21a.

The first optical element 1 further includes a third microstructure layer 13b on the third surface 11b. The third microstructure layer 13b has a same size and shape as the first microstructure layer 13a and is aligned with the first microstructure layer 13a. The third microstructure layer 13b includes a plurality of third prisms 131b. Each third prism 131b includes a third light-transmitting surface LT3 for transmitting light and a third light-blocking surface LB3 for blocking light. Each third prism 131b is aligned with a corresponding one first prism 131a. The third light-transmitting surface LT3 of each third prism 131b is parallel to the first light-transmitting surface LT1 of the corresponding first prism 131a, and the third light-blocking surface LB3 of each third prism 131b is parallel to the first light-blocking surface LB1 of the corresponding first prism 131a.

The second optical element 2 further includes a fourth microstructure layer 23b on the fourth surface 21b. The fourth microstructure layer 23b has a same size and shape as the first microstructure layer 13a and is aligned with the second microstructure layer 23a. The fourth microstructure layer23b includes a plurality of fourth prisms 231b. Each fourth prism 231b includes a fourth light-transmitting surface LT4 for transmitting light and a fourth light-blocking surface LB4 for blocking light. Each fourth prism 231b is aligned with a corresponding second prism 231a. The fourth light-transmitting surface LT4 of each fourth prism 231b is parallel to the second light-transmitting surface LT2 of the corresponding second prism 231a. The fourth light-blocking surface LB4 of each fourth prism 231b is parallel to the second light-blocking surface LB2 of the corresponding second prism 231a.

As shown in FIG. 4 and FIG. 5, after the first splicing surface 14 and the second splicing surface 24 are joined, the fourth surface 21b is coplanar with the third surface 11b, and the fourth microstructure layer 23b is aligned with the third microstructure layer 13b. The fourth light-transmitting surface LT4 of each fourth prism 231b is parallel to the third light-transmitting surface LT3 of any one of third prism 131b, and the fourth light-blocking surface LB4 of each fourth prism 231b is parallel to the third light-blocking surface LB3 of any one of the third prisms 131b.

In FIG. 3, each first prisms 131a, each second prism 231a, each third prism 131b, and each fourth prism 231b is in the shape of a triangular prism. In other embodiments, each first prisms 131a, each second prism 231a, each third prism 131b, and each fourth prism 231b may be in the shape of a cylinder or other protrusions of any shape.

A thickness of the first optical element 1 ranges from 3 mm to 100 mm (for example, 3 mm to 20 mm, 20 mm to 50 mm, 50 mm to 100 mm), to achieve a good splicing effect without affecting the performance and light output of the spliced optical element. A thickness of the second optical element 2 ranges from 3 mm to 100 mm (for example, 3 mm to 20 mm, 20 mm to 50 mm, 50 mm to 100 mm), to achieve a good splicing effect without affecting the performance and light output of the spliced optical element.

The first substrate 11 further includes a first non-splicing area 12a defined by the boundary of the first microstructure layer 13a and a first splicing area 12 connected to and surrounding the first non-splicing area 12a. The protrusion 15 is in the first splicing area 12. The second substrate 21 includes a second non-splicing area 22a defined by the boundary of the second microstructure layer 23a and a second splicing area 22 connected to and surrounding the second non-splicing area 22a. The recess 25 is in the second splicing area 22. The width of the first splicing area 12 is the first width D1. In some embodiments, the length of the first width D1 ranges from 3 mm to 6 mm (e. g; 3 mm to 4 mm, 4 mm to 5 mm, 5 mm to 6 mm). That is, a minimum distance between a boundary of the first microstructure layer 13a and the first splicing surface 14 ranges from 3 mm to 6 mm, which can meet specific processing requirements without affecting the performance and light extraction efficiency of the optical element.

The width of the second splicing area 22 is the second width D2, and the length range of the second width D2 ranges from 3 mm to 6 mm (for example, 3 mm to 4 mm, 4 mm to 5 mm, 5 mm to 6 mm). That is, a minimum distance between a boundary of the second microstructure layer 23a and the second splicing surface 24 ranges from 3 mm to 6 mm, which can meet specific processing needs while does not affect the performance of optical element and light output efficiency.

The number of protrusions 15 can be one, two or more. A shape of the protrusion 15 is any one of a cube, a cuboid, a triangular prism, a cone, a cylinder, or a plunger.

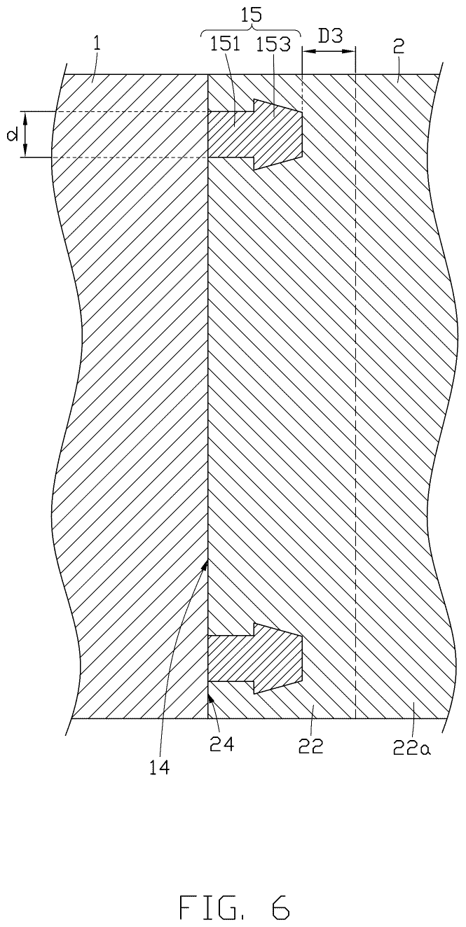

As shown in FIG. 6, the shape of the protrusion 15 is a plunger. Each protrusion 15 includes a cylindrical connecting portion 151 connected to the first splicing surface 14 and a truncated cone-shaped holding portion 153 connected to the connecting part 151. After the first optical element 1 and the second optical element 2 are spliced, each protrusion 15 is accommodated in the corresponding recess 25, and the holding portion 153 can be relatively firmly engaged in the recess 25. The diameter d of the connecting portion 151 is half of the thickness h of the first substrate 11, which is beneficial to strengthen the overall strength of the optical element 200.

In one embodiment, a gap distance D3 between the protrusion 15 and the second microstructure layer 23a is greater than 0.2 mm. For example, in FIG. 6, the protrusion 15 is a plunger and the first splicing surface 14 and the second splicing surface 24 are in contact, the gap distance D3 between the engaging portion 153 and the second microstructure layer 23a is greater than 0.2 mm to prevent the distance D3 from being too close and affecting the overall strength of the spliced optical element.

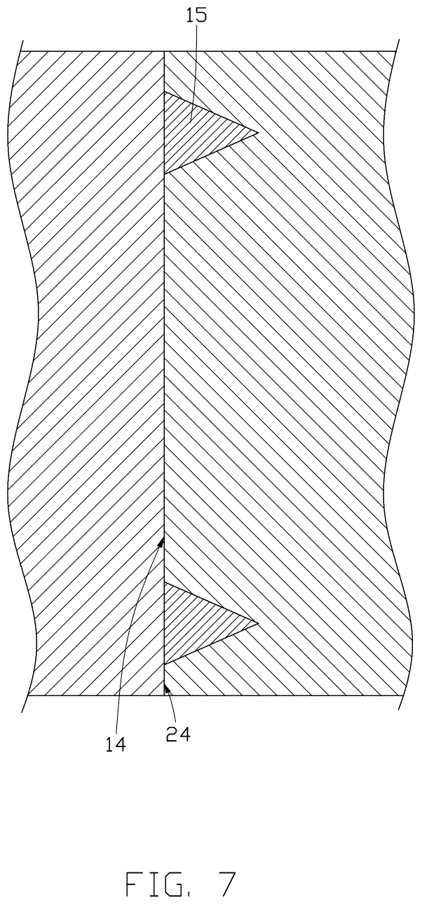

As shown in FIG. 7, the shape of the protrusion 15 is a cone. After the first optical element 1 and the second optical element 2 are spliced, the first splicing surface 14 and the second splicing surface 24 are attached, the cone-shaped protrusion 15 is accommodated in the recess 25, and the cone-shaped protrusion 15 abuts against the second splicing surface 24.

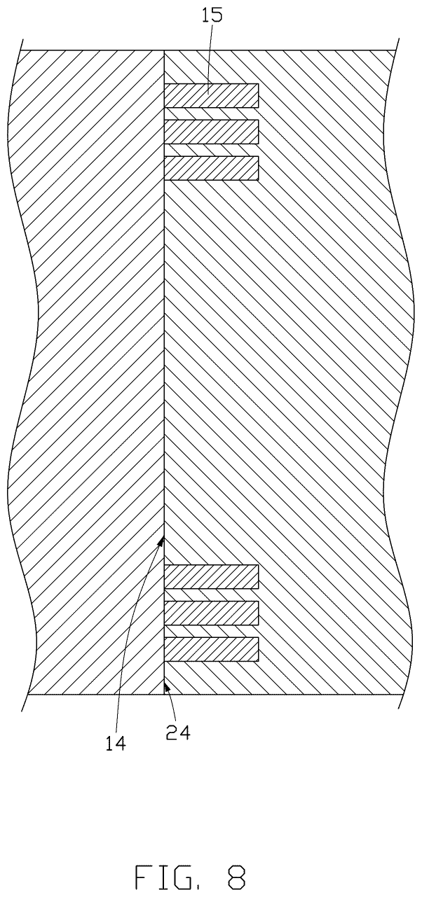

As shown in FIG. 8, the first optical element 1 includes six protrusions 15, and the shape of each protrusion 15 is a cylinder. After the first optical element 1 and the second optical element 2 are spliced, each cylindrical protrusion 15 is accommodated in one corresponding recess 25, and the cylindrical protrusion 15 abuts against the second splicing surface 24. Compared with the cone-shaped protrusion 15, the cylindrical protrusion 15 increases the area of the protrusion 15 and the second splicing surface 24. The number and shape of the protrusions 15 are determined according to the material of the first substrate 11 and the usage requirements.

In the splicing method of optical elements in the embodiment of the present disclosure, each recess 25 is interference-fitted with the corresponding protrusion 15, which is beneficial to reducing the positional deviation of the first splicing surface 14 and the second splicing surface 24, which is beneficial to improve the performance and light output efficiency of the spliced optical elements.

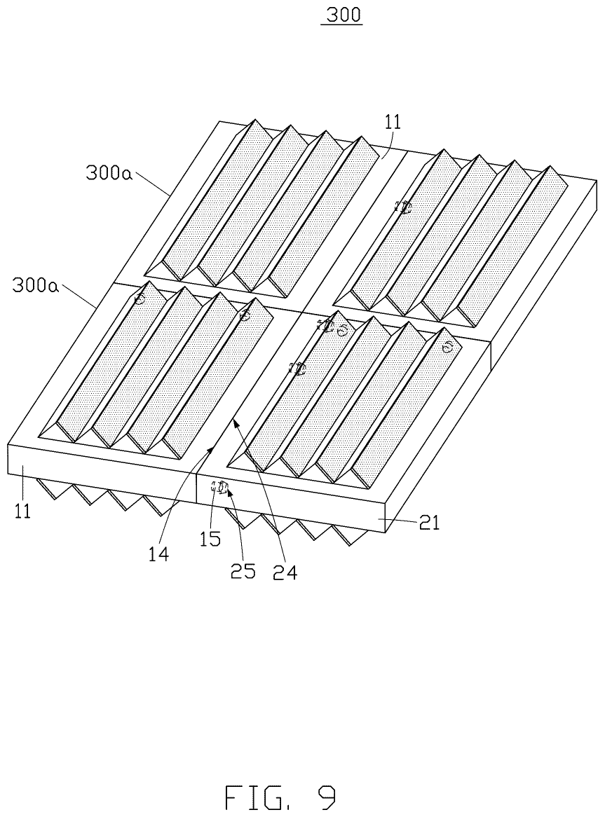

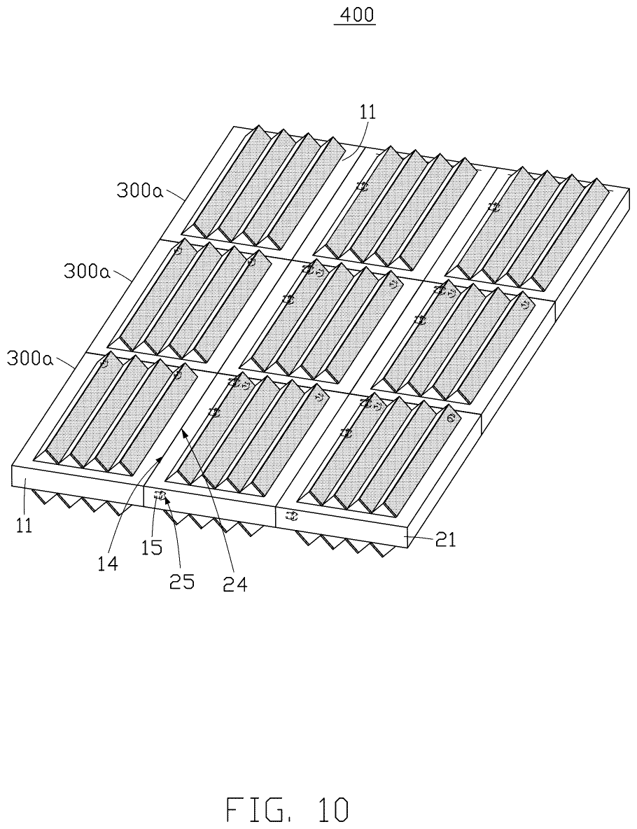

As shown in FIG. 9, four sub-optical elements 300 a are spliced to an optical element 300. As shown in FIG. 10, nine sub-optical elements 300a are spliced into an optical element 400. In other embodiments, three, five or even more sub-optical elements 300a can be spliced into optical elements. The maximum the length and width of the spliced optical elements is 3000 mm×3000 mm. When the length and width of the optical elements are within this range, a good splicing effect can be obtained without affecting the performance and light output efficiency of the spliced optical elements. One structure of the two adjacent sub-optical elements 300a is the same as the first optical element 1, and the other one is the same as the second optical element 2.

The optical element 200 (300, 400) can be used in a head-up display device, a near-eye display device, a projection device, a microscope device, or a telescope device.

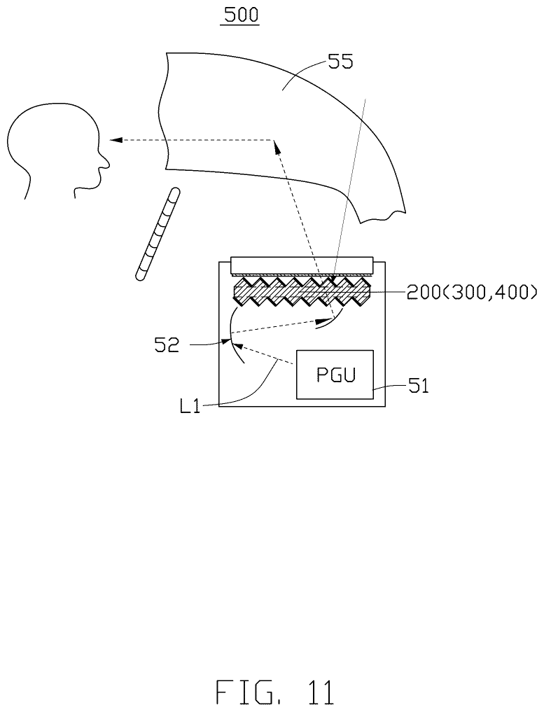

As shown in FIG. 11, the display device 500 includes the optical element 200 (300, 400), an image generating unit 51 and a light guide component 52. The image generating unit 51 is used to emit image light L1. The light guide component 52 is used to receive and guide the image light L1 to the optical element 200 (300, 400). The optical element 200 (300, 400) is used to receive the image light L1 emitted from the light guide assembly 52 and emit the image light L1 to the projection medium 55 for imaging.

The display device 500 is a windshield-type head-up display device. In other embodiments, the display device 500 may be a combined head-up display device, an augmented reality head-up display device, or a holographic projection head-up display device. When the display device 500 is a combined head-up display device, the projection medium 55 can be a semi-reflective and semi-transparent receiving screen. When the display device 500 is a holographic projection head-up display device, the light guide component 52 can be a holographic lens, and the projection medium 55 can be a flat optical waveguide. The ultra-thin structure and two-dimensional pupil expansion capability of the flat optical waveguide can reduce the volume of the display device 500. The image generating unit 51 can include a light source (not shown) for generating image light L1, such as an organic light emitting diode, a micro light emitting diode, etc.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. A method for splicing optical elements, comprising:
providing a first optical element and a second optical element, wherein the first optical element comprises a first substrate having a first splicing surface and at least one protrusion protruding from the first splicing surface toward a side away from the first substrate, the second optical element comprises a second substrate having a second splicing surface and at least one recess recessed from the second splicing surface toward the second substrate, and each of the at least one recess being configured to accommodate a corresponding one of the at least one protrusion; and
splicing the first optical element and the second optical element, wherein the first splicing surface is joined to the second splicing surface, and each of the at least one recess is interference-fitted with the corresponding one of the at least one protrusion.

2. The method of claim 1, wherein providing the first optical element and the second optical element comprises:
forming the first optical element by injection molding and forming the second optical element by injection molding.

3. The method of claim 2, wherein forming the first optical element by injection molding comprises:
heating a raw material of the first optical element to obtain a first molten raw material;
injecting the first molten raw material into a first mold;
cooling the first molten raw material in the first mold to obtain a cooled first optical element; and
demolding the cooled first optical element from the first mold;
forming the second optical element by injection molding comprises:
heating a raw material of the second optical element to obtain a second molten raw material;
injecting the second molten raw material into a second mold;
cooling the second molten raw material in the second mold to obtain a cooled second optical element; and
demolding the cooled second optical element from the second mold.

4. The method of claim 1, wherein:
the first substrate comprises a first surface connected to the first splicing surface;
the second substrate comprises a second surface connected to the second splicing surface;
the first optical element further comprises a first microstructure layer on the first surface;
the second optical element further comprises a second microstructure layer having a same size and shape as the first microstructure layer on the second surface; and
after the first splicing surface and the second splicing surface are joined, the second surface is coplanar with the first surface, and the second microstructure layer is aligned with the first microstructure layer.

5. The method of claim 4, wherein:
the first substrate further comprises a third surface connected to the first splicing surface and opposite to the first surface;
the second substrate further comprises a fourth surface connected to the second splicing surface and opposite to the second surface;
the first optical element further comprises a third microstructure layer on the third surface;
the second optical element further comprises a fourth microstructure layer on the fourth surface;
the third microstructure layer has a same size and shape as the first microstructure layer and is aligned with the first microstructure layer;
the fourth microstructure layer has a same size and shape as the first microstructure layer and is aligned with the second microstructure layer; and
after the first splicing surface and the second splicing surface are joined, the third surface is coplanar with the fourth surface, and the fourth microstructure layer is aligned with the third microstructure layer.

6. The method of claim 4, wherein a minimum distance between a boundary of the first microstructure layer and the first splicing surface ranges from 3 mm to 6 mm, and a minimum distance between a boundary of the second microstructure layer and the second splicing surface ranges from 3 mm to 6 mm.

7. The method of claim 4, wherein after the first splicing surface and the second splicing surface are joined, a gap distance between each of the at least one protrusion and the second microstructure layer is greater than 0.2 mm.

8. The method of claim 1, wherein a shape of each of the at least one protrusion is a cube, a cuboid, a triangular prism, a cone, a cylinder, or a plunger.

9. The method of claim 1, wherein a shape of each of the at least one protrusion is a plunger, and each of the at least one protrusion comprises a cylindrical connecting portion connected to the first splicing surface and a truncated cone-shaped holding portion connected to the cylindrical connecting portion.

10. The method of claim 9, wherein a diameter of the cylindrical connecting portion is half a thickness of the first substrate.

11. An optical element, comprising:
a first optical element comprising a first substrate, at least one protrusion, and a first microstructure layer, wherein the first substrate has a first splicing surface and a first surface connected to the first splicing surface, the at least one protrusion is protruded from the first splicing surface toward a side away from the first substrate, and the first microstructure layer is on the first surface; and
a second optical element comprising a second substrate, at least one recess, and a second microstructure layer having a same size and shape as the first microstructure layer, wherein the second substrate has a second splicing surface and a second surface connected to the second splicing surface, the at least one recess is recessed from the second splicing surface toward the second substrate, and the second microstructure layer is on the second surface,
wherein the first splicing surface is joined to the second splicing surface, each of the at least one recess is interference-fitted with the corresponding one of the at least one protrusion, the second surface is coplanar with the first surface, and the second microstructure layer is aligned with the first microstructure layer.

12. The optical element of claim 11, wherein:
the first microstructure layer comprises a plurality of first prisms, each of the plurality of first prisms comprises a first light-transmitting surface for transmitting light and a first light-blocking surface for blocking light;
the second microstructure layer comprises a plurality of second prisms, each of the plurality of second prisms comprises a second light-transmitting surface for transmitting light and a second light-blocking surface for blocking light;
the second light-transmitting surface of each of the plurality of second prisms is parallel to the first light-transmitting surface of any one of the plurality of first prisms; and
the second light-blocking surface of each of the plurality of second prisms is parallel to the first light-blocking surface of any one of the plurality of first prisms.

13. The optical element of claim 12, wherein:
the first substrate further comprises a third surface connected to the first splicing surface and opposite to the first surface;
the second substrate further comprises a fourth surface connected to the second splicing surface and opposite to the second surface;
the first optical element further comprises a third microstructure layer on the third surface;
the second optical element further comprises a fourth microstructure layer on the fourth surface;
the third microstructure layer has a same size and shape as the first microstructure layer and is aligned with the first microstructure layer;
the fourth microstructure layer has a same size and shape as the first microstructure layer and is aligned with the second microstructure layer; and
the third surface is coplanar with the fourth surface, and the fourth microstructure layer is aligned with the third microstructure layer.

14. The optical element of claim 13, wherein:
the third microstructure layer comprises a plurality of third prisms, each of the plurality of third prisms comprises a third light-transmitting surface for transmitting light and a third light-blocking surface for blocking light;
each of the plurality of third prisms is aligned with a corresponding one of the plurality of first prisms, the third light-transmitting surface of each of the plurality of third prisms is parallel to the first light-transmitting surface of the corresponding one of the plurality of first prisms, and the third light-blocking surface of each of the plurality of third prisms is parallel to the first light-blocking surface of the corresponding one of the plurality of first prisms;
the fourth microstructure layer comprises a plurality of fourth prisms, each of the plurality of fourth prisms comprises a fourth light-transmitting surface for transmitting light and a fourth light-blocking surface for blocking light;
each of the plurality of fourth prisms is aligned with a corresponding one of the plurality of second prisms, the fourth light-transmitting surface of each of the plurality of fourth prisms is parallel to the second light-transmitting surface of the corresponding one of the plurality of second prisms, and the fourth light-blocking surface of each of the plurality of fourth prisms is parallel to the second light-blocking surface of the corresponding one of the plurality of second prisms;
the fourth light-transmitting surface of each of the plurality of fourth prisms is parallel to the third light-transmitting surface of any one of the plurality of third prisms, and the fourth light-blocking surface of each of the plurality of fourth prisms is parallel to the third light-blocking surface of any one of the plurality of third prisms.

15. The optical element of claim 11, wherein a minimum distance between a boundary of the first microstructure layer and the first splicing surface ranges from 3 mm to 6 mm, a minimum distance between a boundary of the second microstructure layer and the second splicing surface ranges from 3 mm to 6 mm; and a gap distance between each of the at least one protrusion and the second microstructure layer is greater than 0.2 mm.

16. The optical element of claim 11, wherein a shape of each of the at least one protrusion is a cube, a cuboid, a triangular prism, a cone, a cylinder, or a shape of each of the at least one protrusion is a plunger, and each of the at least one protrusion comprises a cylindrical connecting portion connected to the first splicing surface and a truncated cone-shaped holding portion connected to the cylindrical connecting portion, a diameter of the cylindrical connecting portion is half a thickness of the first substrate.

17. A display device, comprising:
a picture generation for emitting image light;
an optical element for emitting the image light to a projection medium for imaging, and
a light guide element for guiding the image light to the optical element;
wherein the optical element comprises:
a first optical element comprising a first substrate, at least one protrusion, a first microstructure layer, and a third microstructure layer, wherein the first substrate has a first splicing surface, a first surface connected to the first splicing surface, and a third surface connected to the first splicing surface and opposite to the first surface, the at least one protrusion is protruded from the first splicing surface toward a side away from the first substrate, the first microstructure layer is on the first surface, the third microstructure layer has a same size and shape as the first microstructure layer, the third microstructure layer is on the third surface and aligned with the first microstructure layer; and
a second optical element comprising a second substrate, at least one recess, a second microstructure layer, and a fourth microstructure layer, wherein the second substrate has a second splicing surface, a second surface connected to the second splicing surface, and a fourth surface connected to the second splicing surface and opposite to the second surface, the at least one recess is recessed from the second splicing surface toward the second substrate, the second microstructure layer and the fourth microstructure layer each has a same size and shape as the first microstructure layer, the second microstructure layer is on the second surface, the fourth microstructure layer is on the fourth surface and aligned with the second microstructure layer;
wherein the first splicing surface is joined to the second splicing surface, each of the at least one recess is interference-fitted with the corresponding one of the at least one protrusion, the second surface is coplanar with the first surface, and the second microstructure layer is aligned with the first microstructure layer, the third surface is coplanar with the fourth surface, and the fourth microstructure layer is aligned with the third microstructure layer.

18. The display device of claim 17, wherein:
the first microstructure layer comprises a plurality of first prisms, each of the plurality of first prisms comprises a first light-transmitting surface for transmitting light and a first light-blocking surface for blocking light;
the second microstructure layer comprises a plurality of second prisms, each of the plurality of second prisms comprises a second light-transmitting surface for transmitting light and a second light-blocking surface for blocking light, the second light-transmitting surface of each of the plurality of second prisms is parallel to the first light-transmitting surface of any one of the plurality of first prisms, and the second light-blocking surface of each of the plurality of second prisms is parallel to the first light-blocking surface of any one of the plurality of first prisms;
the third microstructure layer comprises a plurality of third prisms, each of the plurality of third prisms comprises a third light-transmitting surface for transmitting light and a third light-blocking surface for blocking light, each of the plurality of third prisms is aligned with a corresponding one of the plurality of first prisms, the third light-transmitting surface of each of the plurality of third prisms is parallel to the first light-transmitting surface of the corresponding one of the plurality of first prisms, and the third light-blocking surface of each of the plurality of third prisms is parallel to the first light-blocking surface of the corresponding one of the plurality of first prisms;
the fourth microstructure layer comprises a plurality of fourth prisms, each of the plurality of fourth prisms comprises a fourth light-transmitting surface for transmitting light and a fourth light-blocking surface for blocking light; each of the plurality of fourth prisms is aligned with a corresponding one of the plurality of second prisms, the fourth light-transmitting surface of each of the plurality of fourth prisms is parallel to the second light-transmitting surface of the corresponding one of the plurality of second prisms, and the fourth light-blocking surface of each of the plurality of fourth prisms is parallel to the second light-blocking surface of the corresponding one of the plurality of second prisms, the fourth light-transmitting surface of each of the plurality of fourth prisms is parallel to the third light-transmitting surface of any one of the plurality of third prisms, and the fourth light-blocking surface of each of the plurality of fourth prisms is parallel to the third light-blocking surface of any one of the plurality of third prisms.

19. The display device of claim 18, wherein a minimum distance between a boundary of the first microstructure layer and the first splicing surface ranges from 3 mm to 6 mm, a minimum distance between a boundary of the second microstructure layer and the second splicing surface ranges from 3 mm to 6 mm; and a gap distance between each of the at least one protrusion and the second microstructure layer is greater than 0.2 mm.

20. The display device of claim 18, wherein a shape of each of the at least one protrusion is a cube, a cuboid, a triangular prism, a cone, a cylinder, or a shape of each of the at least one protrusion is a plunger, and each of the at least one protrusion comprises a cylindrical connecting portion connected to the first splicing surface and a truncated cone-shaped holding portion connected to the cylindrical connecting portion, a diameter of the cylindrical connecting portion is half a thickness of the first substrate.
